(19) United States
(12) Patent Application Publication
(10) Pub. No.: US 2004/0150667 A1
(43) Pub. Date: Aug. 5, 2004

(54) Performing wireless communication in a graphical program

(76) Inventors: Andrew Philip Dove, Austin, TX (US); Miko Hadikusuma, Austin, TX (US); Stephanie E. Rowland, Austin, TX (US)

Correspondence Address: Jeffrey C. Hood, Meyertons, Hood, Kivlin, Kowert & Goetzel PC, P.O. Box 398, Austin, TX, 78767, US

(21) Appl. No.: 10/369,258

(22) Filed: Feb. 18, 2003

Related U.S. Application Data
(60) Provisional application No. 60/443,711, filed on Jan. 30, 2003.

(51) Int. Cl. G09G 5/00; G06F 9/44

(52) U.S. Cl. 345/763; 717/105

(57) ABSTRACT

A graphical program may be created and configured to perform wireless communication. The user may include one or more wireless communication nodes provided by the graphical programming development environment in the graphical program. The wireless communication nodes may be operable to wirelessly send data to a remote computer system and/or may be operable to receive data sent wirelessly from the remote computer system. The graphical program may then be executed to perform the wireless communication.

### PRIORITY CLAIM

This application claims benefit of priority of U.S. provisional application Serial No. 60/443,711 titled “Performing Wireless Communication in a Graphical Program” filed Jan. 30, 2003, whose inventors are Andrew Philip Dove, Miko Hadikusuma and Stephanie E. Rowland.

### FIELD OF THE INVENTION

The present invention relates to the field of graphical programming, and more particularly to a system and method for enabling a graphical program to perform wireless communication.

### DESCRIPTION OF THE RELATED ART

Traditionally, high level text-based programming languages have been used by programmers in writing application programs. Many different high level programming languages exist, including BASIC, C, Java, FORTRAN, Pascal, COBOL, ADA, APL, etc. Programs written in these high level languages are translated to the machine language level by translators known as compilers or interpreters. The high level programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

Examples of fields in which computer systems are employed to interact with physical systems are the fields of instrumentation, process control, industrial automation, and simulation. Computer measurement and control of devices such as instruments or industrial automation hardware has become increasingly desirable in view of the increasing complexity and variety of instruments and devices available for use. However, due to the wide variety of possible testing and control situations and environments, and also the wide array of instruments or devices available, it is often necessary for a user to develop a custom program to control a desired system.

As discussed above, computer programs used to control such systems traditionally had to be written in text-based programming languages such as, for example, assembly language, C, FORTRAN, BASIC, etc. Traditional users of these systems, however, often were not highly trained in programming techniques and, in addition, text-based programming languages were not sufficiently intuitive to allow users to use these languages without training. Therefore, implementation of such systems frequently required the involvement of a programmer to write software for control and analysis of instrumentation or industrial automation data. Thus, development and maintenance of the software elements in these systems often proved to be difficult.

U.S. Pat. Nos. 4,901,221; 4,914,568; 5,291,587; 5,301,301; and 5,301,336; among others, to Kodosky et al disclose a graphical system and method for modeling a process, i.e., a graphical programming environment which enables a user to easily and intuitively model a process. The graphical programming environment disclosed in Kodosky et al can be considered a higher and more intuitive way in which to interact with a computer. A graphically based programming environment can be represented at a level above text-based high level programming languages such as C, Basic, Java, etc.

The method disclosed in Kodosky et al allows a user to construct a diagram using a block diagram editor. The block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

Therefore, Kodosky et al teaches a graphical programming environment wherein a user places or manipulates icons and interconnects or “wires up” the icons in a block diagram using a block diagram editor to create a graphical “program.” A graphical program for performing an instrumentation, measurement or automation function, such as measuring a Unit Under Test (UUT) or device, controlling or modeling instruments, controlling or measuring a system or process, or for modeling or simulating devices, may be referred to as a virtual instrument (VI). Thus, a user can create a computer program solely by using a graphically based programming environment. This graphically based programming environment may be used for creating virtual instrumentation systems, modeling processes, control, simulation, and numerical analysis, as well as for any type of general programming.

A graphical program may have a graphical user interface. For example, in creating a graphical program, a user may create a front panel or user interface panel. The graphical user interface may include various graphical user interface elements or front panel objects, such as user interface controls and/or indicators that represent or display the respective input and output used or produced by the graphical program or VI, and may include other icons which represent devices being controlled. The graphical user interface may be comprised in a single window of user interface elements, or may comprise a plurality of individual windows each having one or more user interface elements, wherein the individual windows may optionally be tiled together. When the user interface controls and indicators are created, corresponding icons or terminals may be automatically created in the block diagram. Alternatively, the user can place terminal icons in the block diagram which may cause the display of corresponding user interface elements in the graphical user interface, either at edit time or later at run time. As another example, the graphical user interface panel may comprise user interface elements or front panel objects, e.g., the GUI, embedded in the block diagram. Further, the user interface may be characterized as a “front panel” where the user may interactively control or manipulate the input being provided to the graphical program and view the resulting output during program execution.

During creation of the block diagram portion of the graphical program, the user may select various function nodes or icons that accomplish his desired result and connect the function nodes together. For example, the function nodes may be connected in one or more of a data flow, control flow, and/or execution flow format. The function nodes may also be connected in a “signal flow” format, which is a subset of data flow. The function nodes may be connected between the terminals of the various user interface elements, e.g., between the respective controls and indicators. Thus the user may create or assemble a graphical program, referred to as, a block diagram, graphically representing the desired process. The assembled graphical program may be represented in the memory of the computer system as data structures and/or program instructions. The assembled graphical program, i.e., these data structures, may then be compiled or interpreted to produce machine language that accomplishes the desired method or process as shown in the block diagram.

Input data to a graphical program may be received from any of various sources, such as from a device, unit under test, a process being measured or controlled, another computer program, or from a file. Also, a user may input data to a graphical program or virtual instrument using a graphical user interface, e.g., a front panel as described above. The input data may propagate through the block diagram or graphical program and appear as changes on the output indicators. In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators. Alternatively, the user interface may be used merely to view the input and output, or just the output, and the input may not be interactively manipulable by the user during program execution.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, simulation, image processing/machine vision applications, and motion control, among others.

In parallel with the development of the graphical programming model, various technologies for performing wireless communication have been created. Wireless communication includes forms of communication in which information is exchanged without the use of wires. For example, wireless communication typically involves transmitting data using available parts of the electromagnetic spectrum, such as infrared radiation, microwaves, and radio waves. Examples of wireless communication applications include cell phones, two-way radios, wireless computer networking, local communication among computer peripherals, etc.

It is often necessary for a computer program to perform wireless communication. In particular, wireless communication has become important in many applications in which graphical programs are involved. However, graphical programs heretofore have not had the ability to perform wireless communication. Thus, it is desirable to provide a system and method for enabling a graphical program to perform wireless communication.

### SUMMARY

According to one embodiment of the invention, a graphical program may be created and configured to perform wireless communication. In various embodiments, configuring the graphical program to perform the wireless communication may be performed in various ways. In one embodiment, configuring the graphical program to perform the wireless communication may comprise including graphical source code operable to perform the wireless communication in the graphical program. For example, one or more nodes operable to perform the wireless communication may be included in the graphical program.

For example, the user may include a first node in the graphical program, e.g., a wireless communication node provided by the graphical programming development environment. The first node (wireless communication node) may be operable to wirelessly send data to a remote computer system and/or may be operable to receive data sent wirelessly from the remote computer system. (There may be separate nodes for sending data and receiving data.) For example, the user may connect a wire from a second node in the graphical program to the first node. The wire may visually indicate that data is propagated from the second node to the first node. During execution of the graphical program, the first node (also referred to in this instance as a wireless communication send node) may be operable to wirelessly send the data propagated from the second node to the first node, e.g., by controlling wireless communication hardware coupled to the computer system to cause the wireless communication hardware to wirelessly send the data.

Similarly, the user may connect a wire from a first node to a second node in the graphical program, where the wire visually indicates that data is propagated from the first node to the second node. During execution of the graphical program, the first node (also referred to in this instance as a wireless communication receive node) may be operable to wirelessly receive data, e.g., by interacting with the wireless communication hardware to receive the data, and may be operable to propagate the received data to the second node.

In one embodiment, the user may configure the first node with connection information specifying where to send the data or where to receive the data from. The connection information may comprise any of various kinds of information, depending on the particular wireless communication protocol used. For example, in one embodiment the connection information may include information specifying a network address, such as an IP address. In another embodiment, the connection information may include other information specifying where to establish a connection, such as a service name, device ID, etc.

In one embodiment, a wireless communication send node may be responsible primarily for sending data, and a wireless communication receive node may be responsible primarily for receiving data. The user may also include additional supporting nodes related to the wireless communication in the graphical program. The supporting nodes may be operable to perform tasks such as opening and closing wireless connections and may thus be configured with connection information as described above. In one embodiment, the supporting nodes may be interconnected with the wireless communication send nodes and wireless communication receive nodes. For example, an Open Connection node may be operable to open a wireless connection and may supply an output which references the opened wireless connection. This output may be wired as an input to a wireless communication send node to specify where the wireless communication send node should send the data. Similarly, the output from the Open Connection node may be wired as an input to a wireless communication receive node to specify where the wireless communication receive node should receive data from.

In various embodiments, wireless communication nodes may be included in the graphical program to configure the graphical program to perform any kind of wireless communication, such as infrared communication, wireless Ethernet (802.11) communication, and Bluetooth communication, among others. The functions performed by the individual wireless communication nodes included in the graphical program and the relationships of the wireless communication nodes to each other may depend on the particular wireless communication protocol being utilized.

In one embodiment, the graphical programming development environment may provide multiple sets of wireless communication nodes, where each set is related to a different wireless communication protocol. Thus, the user may include wireless communication nodes from the appropriate set in the graphical program to configure the graphical program to perform the desired wireless communication protocol.

In another embodiment, the graphical program may be configured to perform wireless communication without including specialized wireless communication nodes in the block diagram of the graphical program. For example, the user may be able to set properties associated with a particular data source in the graphical program (e.g., an output terminal of a function node) to specify that data generated by the data source is to be wirelessly sent to a remote computer system. Similarly, the user may be able to set properties associated with a particular data sink (e.g., an input terminal of a function node) to specify that data utilized by the data sink is to be wirelessly received from a remote computer system.

The graphical program may be stored in a memory of a first computer system. The first computer system may be the same computer system used to create the graphical program or may be a different computer system. In one embodiment the graphical program may be created on one computer system and then deployed or stored on another computer system or device.

The graphical program may be executed on the first computer system. The graphical program may execute to perform the wireless communication which it was configured to perform as described above. Performing the wireless communication may involve interacting with wireless communication hardware on the first computer system to send and/or receive data.

In one embodiment, the graphical program may be configured to communicate wirelessly with a second program executing on a second computer system. Thus, the method may also comprise executing the second program on the second computer system. The graphical program may perform wireless communication to exchange data with the second program, i.e., to send data to and/or receive data from the second program.

### BRIEF DESCRIPTION OF THE DRAWINGS

A better understanding of the present invention can be obtained when the following detailed description of the preferred embodiment is considered in conjunction with the following drawings, in which:

FIGS. 1A and 1B illustrate exemplary computer systems 82 operable to execute a graphical program configured to perform wireless communication;

FIG. 2 illustrates a graphical program executing on the computer system 82 to communicate wirelessly with a computer system 90;

FIG. 3A illustrates an instrumentation control system;

FIG. 3B illustrates an industrial automation system;

FIG. 4 is a block diagram representing one embodiment of the computer system 82;

FIG. 5 illustrates an exemplary graphical programming development environment;

FIG. 6 is a flowchart diagram illustrating one embodiment of a method for performing wireless communication;

FIG. 7 illustrates a hierarchy of graphical program node palettes, including a palette having a set of nodes for performing infrared wireless communication;

FIGS. 8-14 illustrate an exemplary set of LabVIEW nodes for performing infrared communication according to the IrDA specifications;

FIGS. 15 and 16 illustrate exemplary graphical programs utilizing the IrDA nodes shown in FIGS. 8-14; and

FIG. 17 illustrates one embodiment of a method for using wireless TCP/IP communication with a handheld computing device to access other devices and the services those devices offer.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. patent application Ser. No. 09/617,600 titled “Graphical Programming System with Distributed Block Diagram Execution and Front Panel Display,” filed Jun. 13, 2000.

U.S. patent application Ser. No. 09/518,492 titled “System and Method for Programmatically Creating a Graphical Program,” filed Mar. 3, 2000.

U.S. patent application Ser. No. 09/745,023 titled “System and Method for Programmatically Generating a Graphical Program in Response to Program Information,” filed Dec. 20, 2000.

U.S. patent application Ser. No. 09/974,601 titled “System and Method for Deploying a Graphical Program to a PDA Device,” filed Oct. 9, 2001.

The LabVIEW and BridgeVIEW graphical programming manuals, including the “G Programming Reference Manual”, available from National Instruments Corporation, are also hereby incorporated by reference in their entirety.

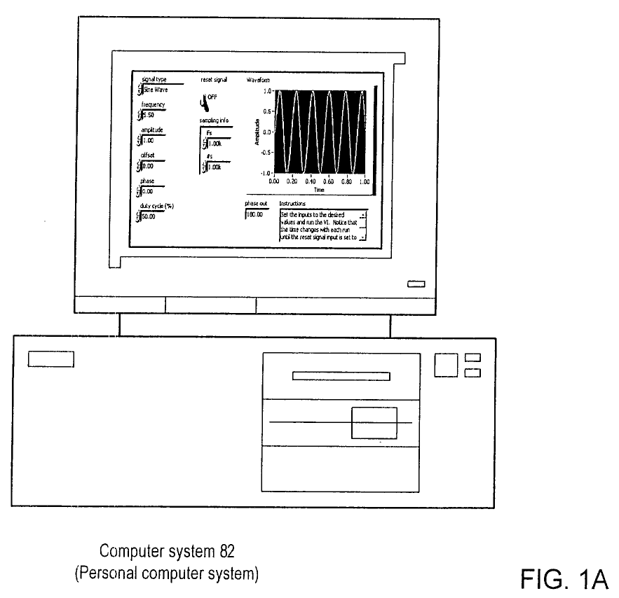

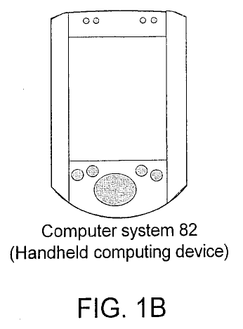

FIGS. 1A and 1B

FIG. 1A illustrates a computer system 82 operable to execute a graphical program configured to perform wireless communication. As used herein, the term wireless communication may include any of various kinds of communication in which information is exchanged without the use of wires. For example, wireless communication may involve transmitting data using available parts of the electromagnetic spectrum, such as infrared radiation, microwaves, or radio waves.

In various embodiments, the graphical program may perform wireless communication according to any of various wireless technologies or communication protocols. For example, in one embodiment the graphical program may be operable to perform infrared communication, e.g., may interact with or control an infrared device to send and/or receive data. In one embodiment the infrared communication may be performed according to an IrDA standard defined by the Infrared Data Association. As another example, in one embodiment the graphical program may be operable to perform wireless Ethernet communication, e.g., may communicate according to the 802.11b or 802.11a standard. In other embodiments, the graphical program may be operable to perform any other type of wireless communication, such as Bluetooth communication, HomeRF communication, wireless TCP/IP communication, etc.

In various embodiments, the graphical program may execute on any of various types of devices or computer systems 82. For example, FIG. 1A illustrates an exemplary personal computer system. In another embodiment, the graphical program may execute on a handheld computing device, such as shown in FIG. 1B. As used herein, the term handheld computing device may include any of various types of devices operable to execute computer programs, where the devices are designed to be held in a user's hand or worn on a user's person. Examples of handheld computing devices include personal digital assistants (PDAs), cellular telephones, handheld game devices, global positioning system (GPS) devices, etc. In addition to the computer systems 82 shown in FIGS. 1A and 1B, in other embodiments the graphical program may execute on any other kind computer system, such as a mainframe computer system, workstation, network appliance, Internet appliance, television system, programmable measurement device, etc. In general, the term “computer system” can be broadly defined to encompass any device having at least one processor that executes instructions from a memory medium.

The computer system 82 on which the graphical program executes may include wireless communication hardware that is utilized to perform the wireless communication. The graphical program may interact with or control the wireless communication hardware to send and/or receive data wirelessly. In various embodiments, the computer system 82 may include any kind of wireless communication hardware. For example, where the computer system 82 includes an infrared device, the graphical program may be operable to perform infrared communication. Similarly, where the computer system includes a wireless Ethernet card, the graphical program may be operable to perform wireless Ethernet communication.

In one embodiment, the computer system 82 may include a display device operable to display the graphical program as the graphical program is created and/or executed. The display device may also be operable to display a graphical user interface or front panel of the graphical program during execution of the graphical program, e.g., as shown in FIG. 1A. The graphical user interface may comprise any type of graphical user interface, e.g., depending on the computing platform.

The computer system 82 may include a memory medium(s) on which one or more computer programs or software components may be stored according to one embodiment of the present invention. For example, the memory medium may store one or more graphical programs which are executable to perform wireless communication such as described herein. Also, in one embodiment the memory medium may store a graphical programming development environment application used to create and/or execute such graphical programs. The memory medium may also store operating system software, as well as other software for operation of the computer system.

The term “memory medium” is intended to include an installation medium, e.g., a CD-ROM, floppy disks 104, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution.

In the present application, the term “graphical program” or “block diagram” is intended to include a program comprising graphical code, e.g., two or more interconnected nodes or icons, wherein the interconnected nodes or icons may visually indicate the functionality of the program. The nodes may be connected in one or more of a data flow, control flow, and/or execution flow format. The nodes may also be connected in a “signal flow” format, which is a subset of data flow. Thus the terms “graphical program” or “block diagram” are each intended to include a program comprising a plurality of interconnected nodes or icons which visually indicate the functionality of the program. A data flow graphical program or data flow diagram refers to a graphical program or block diagram wherein the interconnections between nodes or blocks indicate that data produced by one block is used by another block.

A graphical program may also comprise a user interface or front panel. The user interface portion may be contained in the block diagram or may be contained in one or more separate panels or windows. The user interface of a graphical program may include various graphical user interface elements or front panel objects, such as user interface controls and/or indicators, that represent or display the respective input and/or output used or produced by the graphical program or VI, and may include other icons which represent devices being controlled. The user interface may be comprised in a single window of user interface elements, or may comprise a plurality of individual windows each having one or more user interface elements, wherein the individual windows may optionally be tiled together. As another example, the user interface may comprise user interface or front panel objects, e.g., the GUI, embedded in the block diagram. The user interface of a graphical program may display only output, only input, or both input and output. Further, the user interface may be characterized as a “front panel” where the user may interactively control or manipulate the input being provided to the graphical program and view the resulting output during program execution.

Examples of graphical programming development environments that may be used to create graphical programs include LabVIEW, DasyLab, and DiaDem from National Instruments, VEE from Agilent, WiT from Coreco, Vision Program Manager from PPT Vision, SoftWIRE from Measurement Computing, Simulink from the MathWorks, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others. In the preferred embodiment, the system uses the LabVIEW graphical programming system available from National Instruments.

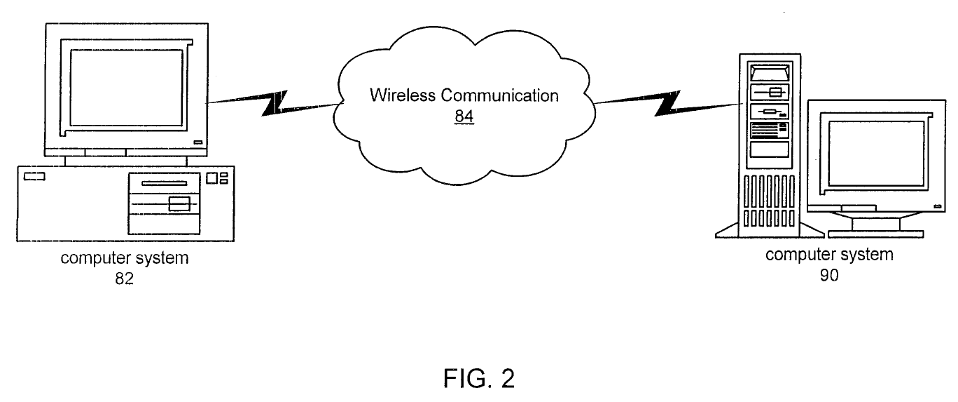

FIG. 2

In various embodiments the computer system 82 may execute the graphical program to communicate wirelessly with any of various types of other devices or computer systems. For example, FIG. 2 illustrates the graphical program executing on the computer system 82 to communicate wirelessly with a computer system 90. The computer system 90 may be any kind of computer system and may be the same type or different from the computer system 82. As one example, the computer system 82 and the computer system 90 may both be desktop computer systems. As another example, the computer system 82 may be a handheld computing device such as a PDA, and the computer system 90 may be a desktop computer system, or vice versa. As another example, the computer system 82 and the computer system 90 may both be handheld computing devices. As another example, the computer system 82 may be a desktop computing system, and the computer system 90 may be a network device for managing network traffic.

In one embodiment the graphical program executing on the computer system 82 may perform the wireless communication to communicate with another program executing on the computer system 90. In one embodiment, the two programs may communicate with each other according to a client/server model. In one embodiment the program executing on the computer system 90 may also be a graphical program. In another embodiment the program executing on the computer system 90 may be a text-based program, e.g., a program originally written using a text-based programming language such as C, C++, Visual C++, Visual Basic, Pascal, Java, etc.

In FIG. 2, the computer system 82 and the computer system 90 may be physically located any distance from each other. For example, in one embodiment the two computer systems may be located relatively close to each other, such as when the computer systems use infrared communication to communicate with each other. In another embodiment, the two computer systems may be located relatively far apart. In one embodiment, the computer system 90 may not be the final recipient of wireless data sent by the computer system 82, but may instead relay data wirelessly received from the computer system 82 to another computer system 91 (not shown). Similarly, the computer system 90 may relay data received from the computer system 91 to the computer system 82. The computer system 90 may relay the data to and from the computer system 91 using either wired or wireless communication techniques. For example, in one embodiment the computer system 90 may be a network device coupled to a wired network, such as a local area network (LAN) or such as the Internet, and may use a wired communication technique to forward wireless data received from the computer system 82 to a computer system 91 coupled to the wired network. Example LANs include Ethernet networks, Token Ring networks, and various industrial communication networks such as Foundation Fieldbus, DeviceNet, and CAN (Controller Area Network) networks.

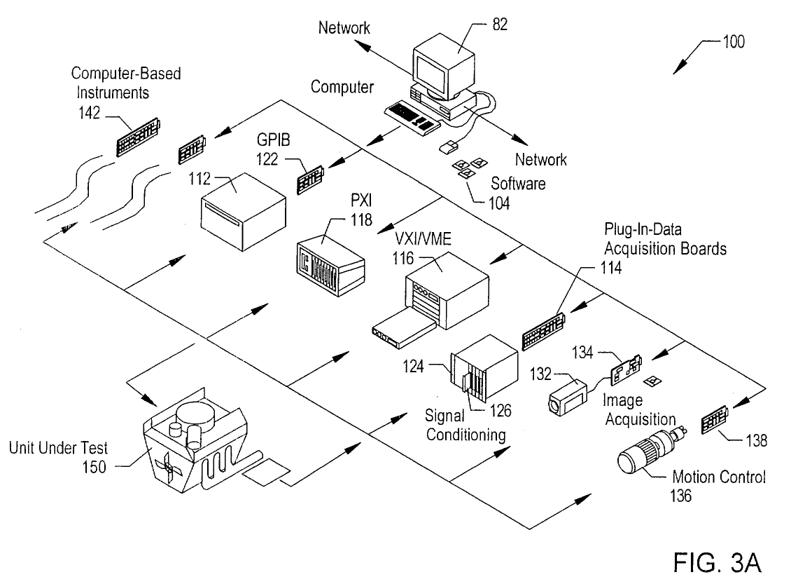

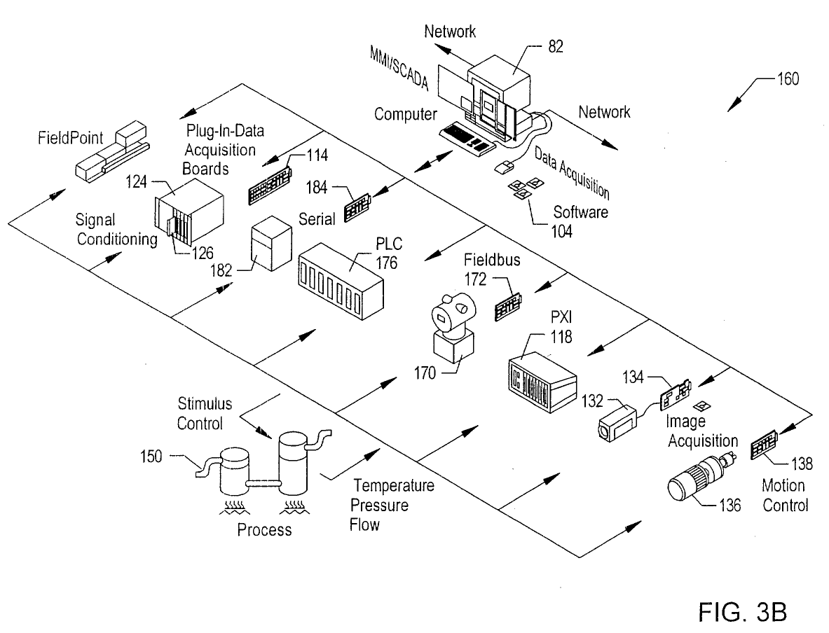

Additional computer systems (not shown) may also couple to the computer systems 82 and/or 90. Various other devices may connect or couple to one or more of the computer systems 82 or 90, or to other computer systems in the system. For example, any one or more of the devices shown in FIGS. 3A and 3B may couple to one or both of the computer systems 82 or 90. Devices may be coupled to the computer systems 82 or 90 via wired or wireless means, such as via a network, a computer bus, e.g., a serial or parallel bus, or other methods. Example parallel buses include the PCI bus, PXI bus, GPIB, and VXI bus, among others. Example serial buses include USB (Universal Serial Bus), IEEE 1394, RS-242, and RS-485, among others.

As used herein, the term “device” is intended to have its ordinary meaning as any of various types of devices, units or components. The term “device” is intended to include “programmable devices” and “non-programmable devices”.

As used herein, the term “programmable device” is intended to include any of various types of devices that include one or more of: 1) a processor and memory; or 2) a programmable hardware element or reconfigurable logic. Exemplary types of processors include a conventional microprocessor or CPU (such as an X86, PowerPC, SunSparc, etc.), a digital signal processor (DSP), microcontroller, or other type of processor. Exemplary types of programmable hardware elements include a programmable logic device (PLD), e.g., an FPGA (field programmable gate array), or other types of reconfigurable logic. It is noted that a program may typically only be deployed to or stored on a programmable device.

Exemplary types of programmable devices include computer systems; network devices; personal digital assistants (PDAs); television systems; measurement devices (including instruments, industrial automation devices, process control devices, smart data acquisition devices, smart sensors (including smart cameras), smart actuators, video devices (e.g., digital cameras, digital video cameras); audio devices; computer peripherals; telephones; appliances; or other processor-based or programmable hardware-based devices. Exemplary measurement and automation devices include any of the devices shown in FIGS. 3A and 3B. Exemplary network devices include network interface cards, routers, bridges, switches, hubs, etc.

The term “non-programmable device” is intended to include any of various components, such as transducers, sensors, connector blocks, cabling, and other non-programmable devices.

FIGS. 3A and 3B—Instrumentation and Industrial Automation Systems

In various embodiments, a graphical program may perform wireless communication for any purpose or application. The following describes embodiments involved with performing test and/or measurement functions and/or controlling and/or modeling instrumentation or industrial automation hardware. However, it is noted that the present invention can be used for a plethora of applications and is not limited to instrumentation or industrial automation applications. In other words, the following description is exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, games, etc.

FIG. 3A illustrates an exemplary instrumentation control system 100. The system 100 comprises a host computer 82 which connects to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

In one embodiment, the computer 82 may execute a graphical program which performs wireless communication. For example, the graphical program may communicate wirelessly with one or more of the instruments to communicate with or control the instrument(s) or to exchange data with a program executing on the instrument(s). In another embodiment, one or more of the instruments may execute a graphical program that communicates wirelessly with the computer 82, e.g., communicates with a graphical program or other program executing on the computer 82.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices.

The GPIB instrument 112 may be coupled to the computer 82 via the GPIB interface card 122 provided by the computer 82. In a similar manner, the video device 132 may be coupled to the computer 82 via the image acquisition card 134, and the motion control device 136 may be coupled to the computer 82 through the motion control interface card 138. The data acquisition board 114 may be coupled to the computer 82, and may interface through signal conditioning circuitry 124 to the UUT. The signal conditioning circuitry 124 may comprise an SCXI (Signal Conditioning extensions for Instrumentation) chassis comprising one or more SCXI modules 126.

The GPIB card 122, the image acquisition card 134, the motion control interface card 138, and the DAQ card 114 are typically plugged in to an I/O slot in the computer 82, such as a PCI bus slot, a PC Card slot, or an ISA, EISA or MicroChannel bus slot provided by the computer 82. However, these cards 122, 134, 138 and 114 are shown external to computer 82 for illustrative purposes. These devices may also be connected to the computer 82 through a serial bus or through other means.

The VXI chassis or instrument 116 may be coupled to the computer 82 via a VXI bus, MxI bus, or other serial or parallel bus provided by the computer 82. The computer 82 may include VXI interface logic, such as a VXI, MXI or GPIB interface card (not shown), which interfaces to the VXI chassis 116. The PXI chassis or instrument may be coupled to the computer 82 through the computer's PCI bus.

A serial instrument (not shown) may also be coupled to the computer 82 through a serial port, such as an RS-232 port, USB (Universal Serial bus) or IEEE 1394 or 1394.2 bus, provided by the computer 82. In typical instrumentation control systems an instrument will not be present of each interface type, and in fact many systems may only have one or more instruments of a single interface type, such as only GPIB instruments.

The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application.

FIG. 3B illustrates an exemplary industrial automation system 160. The industrial automation system 160 is similar to the instrumentation or test and measurement system 100 shown in FIG. 3A. Elements which are similar or identical to elements in FIG. 3A have the same reference numerals for convenience. The system 160 may comprise a computer 82 which connects to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control.

In one embodiment, the computer 82 may execute a graphical program which performs wireless communication. For example, the graphical program may communicate wirelessly with one or more of the devices to communicate with or control the device(s) or to exchange data with a program executing on the device(s). In another embodiment, one or more of the devices may execute a graphical program that communicates wirelessly with the computer 82, e.g., communicates with a graphical program or other program executing on the computer 82.

The one or more devices may include a data acquisition board 114 and associated signal conditioning circuitry 124, a PXI instrument 11 8, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

The DAQ card 114, the PXI chassis 118, the video device 132, and the image acquisition card 134 may be connected to the computer 82 as described above. The serial instrument 182 may be coupled to the computer 82 through a serial interface card 184, or through a serial port, such as an RS-232 port, provided by the computer 82. The PLC 176 may couple to the computer 82 through a serial port, Ethernet port, or a proprietary interface. The fieldbus interface card 172 may be comprised in the computer 82 and may interface through a fieldbus network to one or more fieldbus devices. Each of the DAQ card 114, the serial card 184, the fieldbus card 172, the image acquisition card 134, and the motion control card 138 are typically plugged in to an I/O slot in the computer 82 as described above. However, these cards 114, 184, 172, 134, and 138 are shown external to computer 82 for illustrative purposes. In typical industrial automation systems a device will not be present of each interface type, and in fact many systems may only have one or more devices of a single interface type, such as only PLCs. The devices may be coupled to the device or process 150.

As used herein, the term “instrument” is intended to include any of the devices that are adapted to be connected to a computer system as shown in FIGS. 3A and 3B, traditional “stand-alone” instruments, as well as other types of measurement and control devices. The term “measurement function” may include any type of data acquisition, measurement or control function, such as that implemented by the instruments shown in FIGS. 3A and 3B. For example, the term “measurement function” includes acquisition and/or processing of an image. A graphical program may be created that implements a measurement function. For example, the graphical program may be used to acquire a signal and perform the measurement function on the acquired signal.

In the embodiments of FIGS. 3A and 3B above, one or more of the various instruments may couple to the computer 82 over a network, such as the Internet, an Ethernet network, or other wired or wireless network connection. For example, the user may create or deploy a graphical program on a computer and use the graphical program in conjunction with a target device or instrument that is remotely located from the computer and coupled to the computer through a network.

Graphical software programs which perform data acquisition, analysis and/or presentation, e.g., for measurement, instrumentation control, industrial automation, or simulation, such as in the applications shown in FIGS. 3A and 3B, may be referred to as virtual instruments.

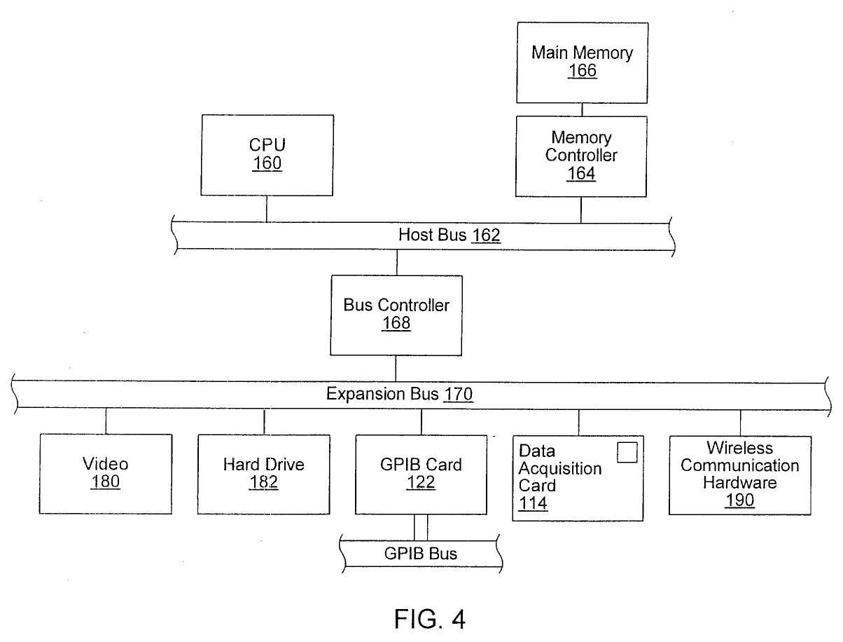

FIG. 4—Computer System Block Diagram

FIG. 4 is a block diagram representing one embodiment of the computer system 82 described above. As noted above, any type of computer system configuration or architecture can be used for the computer system 82 as desired, and FIG. 4 illustrates a representative PC embodiment. It is also noted that the computer system may be a general purpose computer system, a computer implemented on a VXI card installed in a VXI chassis, a computer implemented on a PXI card installed in a PXI chassis, or other types of embodiments. Elements of a computer not necessary to understand the present description have been omitted for simplicity.

The computer may include at least one central processing unit or CPU 160 which is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164. The main memory 166 may store a graphical program operable to perform wireless communication. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as a data acquisition board 114 and a GPIB interface card 122 which provides a GPIB bus interface to a GPIB instrument. The computer 82 further comprises a video display subsystem 180 and hard drive 182 coupled to the expansion bus 170.

As shown, wireless communication hardware 190 may also be coupled to the computer. The manner in which the wireless communication hardware is coupled to the computer may depend on the type of wireless communication hardware used. For example, a wireless Ethernet card may be coupled to the expansion or input/output bus 170 such as shown in FIG. 4. As another example, an infrared device may be connected to an IrDA enabled serial port of the computer via a serial cable. Other types of wireless communication hardware may be coupled to the computer in other ways.

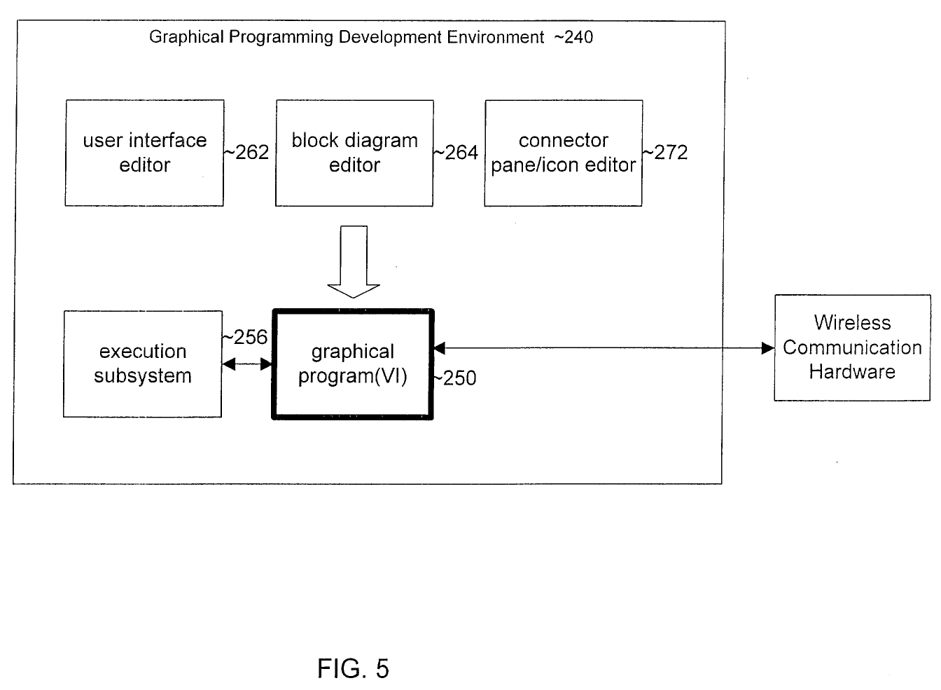

FIG. 5—Exemplary Graphical Programming Development Environment

In various embodiments, a graphical program such as described herein may be created by or may be associated with any of various graphical programming development environments. FIG. 5 illustrates an exemplary graphical programming development environment 240. It is noted that in other embodiments, a graphical programming development environment may have any of various other components and architectures.

In one embodiment, a user may employ a user interface editor 262, a block diagram editor 264, and optionally a connector pane/icon editor 272 of the graphical programming development environment to produce the graphical program. The block diagram editor 264 may be operable to create a block diagram for the graphical program. For example, the user may arrange on the screen a plurality of nodes to create the block diagram. The user may also interconnect the nodes, e.g., to indicate one or more of data flow, control flow, and/or execution flow. The plurality of interconnected nodes may visually indicate functionality of the graphical program.

The user interface editor 262 may be operable to generate a user interface or front panel for the graphical program. For example, the user may arrange on the screen one or more user interface elements, such as controls and indicators. Alternatively, the user interface may be created automatically in response to creation of the block diagram.

In one embodiment, the graphical programming development environment may support the creation of graphical sub-programs. For example, the connector pane/icon editor 272 may be used to form a sub-program, e.g., a graphical program that may be used as a graphical programming element or node in another graphical program.

The graphical program (VI) 250 may include program instructions generated based on the block diagram created using the block diagram editor 264. In one embodiment, the graphical program developed by the user may be executed by an execution subsystem 256 of the graphical programming development environment. In various embodiments, the graphical program may execute to perform any function or application. The graphical program may be configured to perform wireless communication, as described below. As shown, the graphical program may interact with wireless communication hardware 190 to perform the wireless communication.

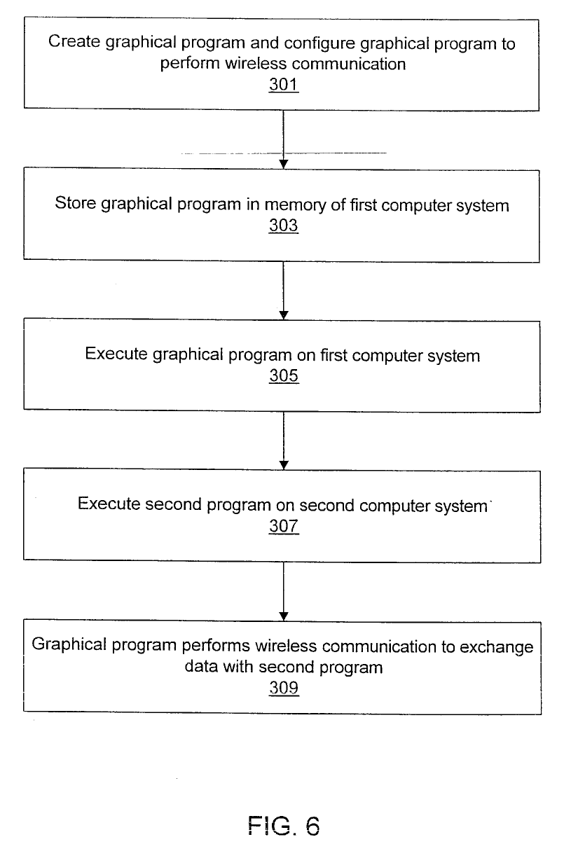

FIG. 6—Flowchart

FIG. 6 is a flowchart diagram illustrating a method for performing wireless communication according to one embodiment of the present invention. It is noted that FIG. 6 illustrates a representative embodiment, and alternative embodiments are contemplated. Also, various elements may be combined, omitted, or performed in different orders.

As shown in 301, a graphical program may be created, and the graphical program may be configured to perform wireless communication. In various embodiments, the graphical program may be created using any graphical programming development environment. Creating the graphical program may include creating a block diagram for the graphical program. The block diagram may be created in response to direct user input, e.g., the user may create the block diagram by placing or “dragging and dropping” icons or nodes on the display and interconnecting the nodes in a desired fashion. Alternatively, the block diagram may be programmatically generated, e.g., as described in the above-incorporated patent application titled, “System and Method for Programmatically Generating a Graphical Program in Response to Program Information”. The plurality of nodes in the block diagram may be interconnected to visually indicate functionality of the graphical program. The block diagram may have one or more of data flow, control flow, and/or execution flow representations.

In one embodiment, creating the graphical program may also include creating a graphical user interface, e.g., in response to user input. The graphical user interface may be created in any of various ways, e.g., depending on the graphical programming development environment used. Creating the graphical user interface may comprise specifying various user interface elements. These user interface elements may include elements such as one or more windows or panels, menu bars, context menus, etc., as well as various user interface controls and indicators for receiving program input and/or displaying program output. Examples of user interface controls and indicators include charts, graphs, push buttons, knobs, numeric controls, text boxes, list boxes, check boxes, etc. For example, the LabVIEW graphical programming development environment, available from National Instruments Corporation, provides various user interface elements for inclusion in a graphical user interface. The kinds of user interface elements that are included in the graphical user interface may vary depending on the targeted platform of the graphical program. For example, if the graphical program is intended to execute on a personal digital assistant (PDA) or handheld computer, then the graphical user interface may include different types of elements than if the graphical program were intended to execute on a desktop computer system.

It is noted that the graphical user interface and the block diagram may be created separately or together, in various orders, or in an interleaved manner. In one embodiment, the user interface elements in the graphical user interface may be specified or created, and terminals corresponding to the user interface elements may appear in the block diagram in response. For example, when the user places user interface elements in the graphical user interface, corresponding terminals may appear in the block diagram as nodes that may be connected to other nodes in the block diagram, e.g., to provide input to and/or display output from other nodes in the block diagram. In another embodiment, the user interface elements may be created in response to the block diagram. For example, the user may create the block diagram, wherein the block diagram includes terminal icons or nodes that indicate respective user interface elements. The graphical user interface may then be automatically (or manually) created based on the terminal icons or nodes in the block diagram. As another example, the graphical user interface elements may be included in the block diagram.

In various embodiments, configuring the graphical program to perform the wireless communication may be performed in various ways. In one embodiment, configuring the graphical program to perform the wireless communication may comprise including graphical source code operable to perform the wireless communication in the graphical program. For example, one or more nodes operable to perform the wireless communication may be included in the graphical program.

For example, the user may include a first node in the graphical program, e.g., a wireless communication node provided by the graphical programming development environment. The first node (wireless communication node) may be operable to wirelessly send data to a remote computer system and/or may be operable to receive data sent wirelessly from the remote computer system. (There may be separate nodes for sending data and receiving data.) For example, the user may connect a wire from a second node in the graphical program to the first node. The wire may visually indicate that data is propagated from the second node to the first node. During execution of the graphical program, the first node (also referred to in this instance as a wireless communication send node) may be operable to wirelessly send the data propagated from the second node to the first node, e.g., by controlling wireless communication hardware coupled to the computer system to cause the wireless communication hardware to wirelessly send the data.

Similarly, the user may connect a wire from a first node to a second node in the graphical program, where the wire visually indicates that data is propagated from the first node to the second node. During execution of the graphical program, the first node (also referred to in this instance as a wireless communication receive node) may be operable to wirelessly receive data, e.g., by interacting with the wireless communication hardware to receive the data, and may be operable to propagate the received data to the second node.

In one embodiment, the user may configure the first node with connection information specifying where to send the data or where to receive the data from. The connection information may comprise any of various kinds of information, depending on the particular wireless communication protocol used. For example, in one embodiment the connection information may include information specifying a network address, such as an IP address. In another embodiment, the connection information may include other information specifying where to establish a connection, such as a service name, device ID, etc.

In one embodiment, a wireless communication send node may be responsible primarily for sending data, and a wireless communication receive node may be responsible primarily for receiving data. The user may also include additional supporting nodes related to the wireless communication in the graphical program. The supporting nodes may be operable to perform tasks such as opening and closing wireless connections and may thus be configured with connection information as described above. In one embodiment, the supporting nodes may be interconnected with the wireless communication send nodes and wireless communication receive nodes. For example, an Open Connection node may be operable to open a wireless connection and may supply an output which references the opened wireless connection. This output may be wired as an input to a wireless communication send node to specify where the wireless communication send node should send the data. Similarly, the output from the Open Connection node may be wired as an input to a wireless communication receive node to specify where the wireless communication receive node should receive data from.

In various embodiments, wireless communication nodes may be included in the graphical program to configure the graphical program to perform any kind of wireless communication, such as infrared communication, wireless Ethernet (802.11) communication, and Bluetooth communication, among others. The functions performed by the individual wireless communication nodes included in the graphical program and the relationships of the wireless communication nodes to each other may depend on the particular wireless communication protocol being utilized.

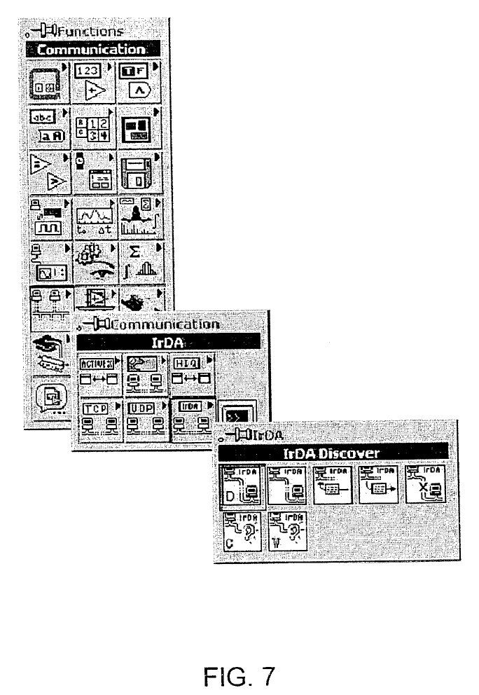

In one embodiment, the graphical programming development environment may provide multiple sets of wireless communication nodes, where each set is related to a different wireless communication protocol. Thus, the user may include wireless communication nodes from the appropriate set in the graphical program to configure the graphical program to perform the desired wireless communication protocol. FIG. 7 illustrates a hierarchy of graphical program node palettes. The bottom-most palette includes a set of nodes for performing infrared communication according to the IRDA specification. Thus, the user may drag and drop IrDA nodes from this palette into the graphical program to enable the graphical program to perform infrared communication. The graphical programming development environment may provide other palettes having other wireless communication nodes for performing other types of wireless communication.

In another embodiment, the graphical program may be configured to perform wireless communication without including specialized wireless communication nodes in the block diagram of the graphical program. For example, the user may be able to set properties associated with a particular data source in the graphical program (e.g., an output terminal of a function node) to specify that data generated by the data source is to be wirelessly sent to a remote computer system. Similarly, the user may be able to set properties associated with a particular data sink (e.g., an input terminal of a function node) to specify that data utilized by the data sink is to be wirelessly received from a remote computer system.

In one embodiment, the graphical programming development environment may be operable to display a graphical user interface enabling the user to specify one or more properties relating to the wireless communication performed by the graphical program. Thus, in one embodiment configuring the graphical program to perform the wireless communication may comprise configuring the graphical program to perform the wireless communication according to the properties specified by the user via the graphical user interface. In one embodiment, the graphical programming development environment may programmatically create graphical source code or modify existing graphical source code in the graphical program according to the input provided by the user. In one embodiment, one or more wireless communication nodes provided by the graphical programming development environment may have their own associated graphical user interfaces for configuring properties of the respective wireless communication nodes. As one example, an Open Connection node may have an associated graphical user interface enabling the user to specify connection information, such as a network address, service name, or device ID.

In 303, the graphical program may be stored in a memory of a first computer system. The first computer system may be the same computer system used to create the graphical program or may be a different computer system. In one embodiment the graphical program may be created on one computer system and then deployed or stored on another computer system or device.

In 305, the graphical program may be executed on the first computer system. The graphical program may execute to perform the wireless communication which it was configured to perform in 301. Performing the wireless communication may involve interacting with wireless communication hardware on the first computer system to send and/or receive data.

In one embodiment, the graphical program may be executed by an execution subsystem of the graphical programming development environment used to create the graphical program. In another embodiment the graphical program may be able to execute on its own. In one embodiment the graphical program may first be converted to another format before being executed on the first computer system. For example, it may be necessary to convert the graphical program to a different format to deploy the graphical program on the first computer system.

In one embodiment, the graphical program may be configured to communicate wirelessly with a second program executing on a second computer system. Thus, the method may also comprise executing the second program on the second computer system, as shown in 307. As shown in 309, the graphical program may perform wireless communication to exchange data with the second program, i.e., to send data to and/or receive data from the second program.

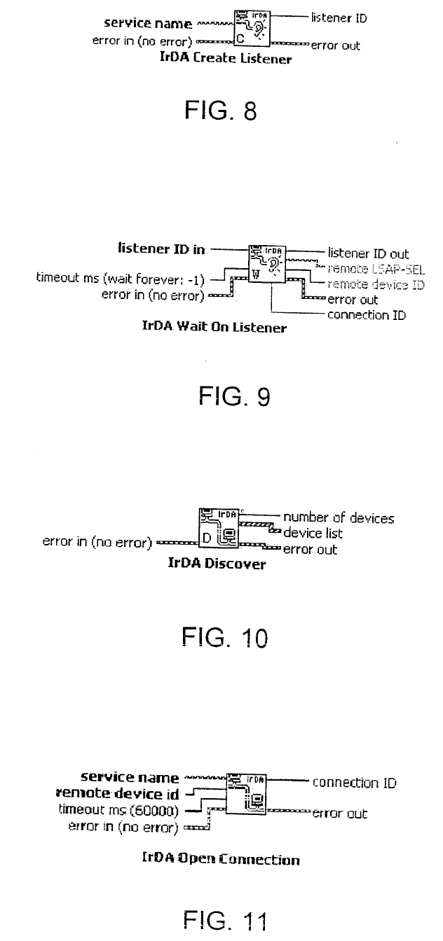

FIGS. 8-16: IRDA Wireless Communication

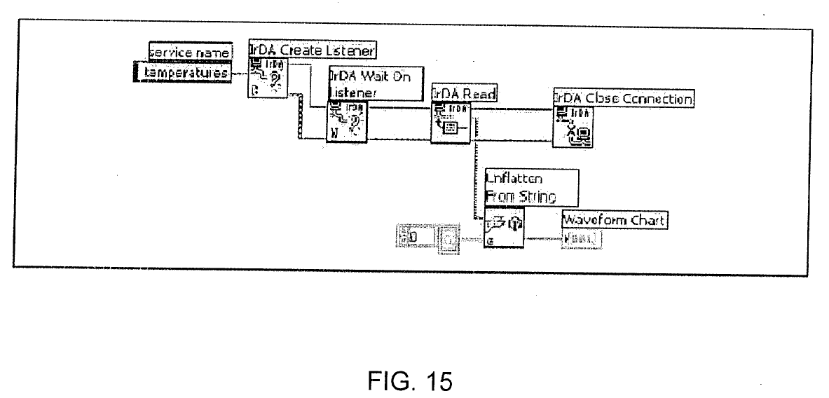

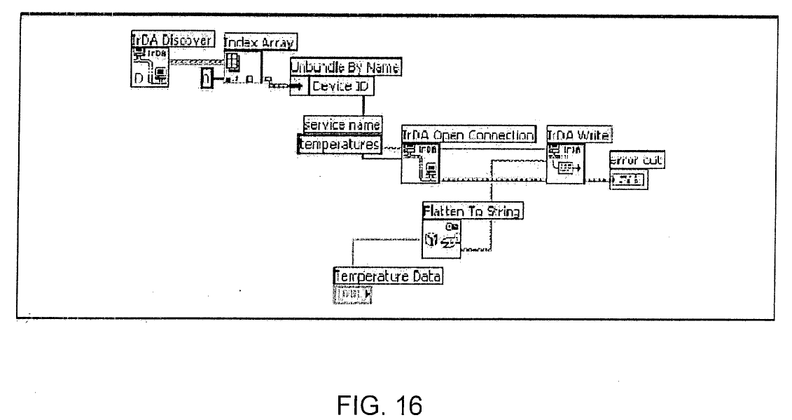

FIGS. 8-14 illustrate an exemplary set of LabVIEW nodes for performing infrared communication according to the IRDA specifications. FIGS. 15 and 16 illustrate exemplary graphical programs utilizing the IrDA nodes shown in FIGS. 8-14. As described above, in various embodiments the graphical program may be configured in any of various ways to perform any type of wireless communication. In other words, FIGS. 8-16 are exemplary only.

An IRDA network is similar to an isolated TCP/IP network where IP addresses can be assigned at random as long as each address on the network is unique. Because an IrDA network is dynamic and devices can enter and leave the network frequently, there are no fixed IrDA addresses that a client can look up to establish communication with a server. When the network detects a computer, the network identifies each device by its name (usually specified by the user) and a dynamically generated unique 32-bit ID.

To establish communication between devices on a wireless network, the IrDA device acting as a server monitors the network for devices attempting to establish communication on the network. The server creates a listener so it can listen for any device that enters the network, as opposed to opening a connection by specifying an address to determine if that device is connected to the network. The listener establishes a service, which is similar to opening a port in TCP, by accessing a free entry in a database on the server called the information access service (LAS) database. The database can include up to 128 entries. Each established service in the IAS database is assigned a Logical Service Access Point Selector (LSAP-SEL), a number ranging from 0 to 127, and a corresponding service ID, which is a string that identifies the service.

The client queries the database with the service ID to find the LSAP-SEL number. After the LSAP-SEL number is established, communication between the devices can begin. For example, the user could identify a service with the service ID temperature so that when the server establishes a connection with a client, it sends a collection of temperatures to the client. The server then listens for a client requesting the service ID temperature. When the client connects to the network, it sends the service temperature to the server, which in turn establishes an LSAP-SEL number for the service. The client then queries the server for the for the LSAP-SEL number corresponding to the temperature service. After the LSAP-SEL number is established, the server sends the temperature data to the client.

For information on IrDA technology, please refer to the IRDA specifications provided by the Infrared Data Association.

FIG. 8 illustrates an IrDA Create Listener node. This node creates a listener for an IrDA connection on a wireless network using the service name and returns a listener ID. After the listener ID has been created, the IrDA Wait on Listener node can be used to wait for the detection of a remote computer. The following describes the inputs and outputs shown for this node:

“service name” identifies the IRDA service used to establish a connection to an IrDA server.

“error in” describes error conditions that occur before this VI or function runs. The default is no error. If an error occurred before this VI or function runs, the VI or function passes the “error in” value to “error out”. This VI or function runs normally only if no error occurred before this VI or function runs. If an error occurs while this VI or function runs, it runs normally and sets its own error status in “error out”. “Error in” and “error out” can be used to check errors and to specify execution order by wiring “error out” from one node to “error in” of the next node.

“listener ID” is the IRDA connection refnum that uniquely identifies the listener.

“error out” contains error information. If “error in” indicates that an error occurred before this VI or function ran, “error out” contains the same error information. Otherwise, it describes the error status that this VI or function produces.

FIG. 9 illustrates an IrDA Wait on Listener node. This node waits for the designated IrDA listener to pass an accepted IrDA network connection. When the infrared sensor attached to the computer detects another IR device requesting service, the server establishes communication between itself and the client. The IrDA Create Listener function is used to create the listener ID. The following describes the inputs and outputs shown for this node:

“listener ID in” is an IrDA connection refnum that uniquely identifies the IrDA listener.

“timeout ms” indicates how long the function should wait for a connection with another IrDA device on a wireless network before the function returns an error. The default is −1, which means the function waits indefinitely.

“error in” is similar as described above with reference to FIG. 8.

“listener ID out” has the same value as “listener ID in”. This value is used to refer to this listener in subsequent IrDA function calls.

“remote LSAP-SEL” is the selector number the remote IrDA device uses for the IrDA connection.

“remote device ID” is the ID of the remote IrDA device on the IrDA network.

“error out” is similar as described above with reference to FIG. 8.

“connection ID out” is the IrDA connection refnum that uniquely identifies the IrDA connection. This value is used to refer to this connection in subsequent IrDA function calls.

FIG. 10 illustrates an IrDA Discover node. This node finds any IrDA-enabled devices within a detectable wireless boundary and returns the ID and name of each device and the number of devices detected. The following describes the inputs and outputs shown for this node:

“error in” is similar as described above with reference to FIG. 8.

“number of devices” indicates how many IRDA devices the function currently detects on the wireless network.

“device list” returns a list of devices the function detects on the wireless network. “device id” identifies a device on the IrDA network. This ID is used to open a connection to a server. “device name” indicates the name of an IrDA device detected.

“error out” is similar as described above with reference to FIG. 8.

FIG. 11 illustrates an IrDA Open Connection node. This node opens an infrared connection to another IrDA-enabled device. The connection can be closed with the IrDA Close Connection function. The following describes the inputs and outputs shown for this node:

“service name” identifies the IrDA service used to establish a connection to an IrDA server.

“remote device ID” is the device ID of the remote IrDA device on the IrDA network. The IrDA Discover function is used to locate the device ID.

“timeout ms” indicates how long the function should wait to make a connection to an IrDA device on a wireless network before the function returns an error. The default is 60,000 ms.

“error in” is similar as described above with reference to FIG. 8.

“connection ID” is an IrDA connection refnum that uniquely identifies the IrDA connection. This value is used to refer to this connection in subsequent IrDA function calls.

“error out” is similar as described above with reference to FIG. 8.

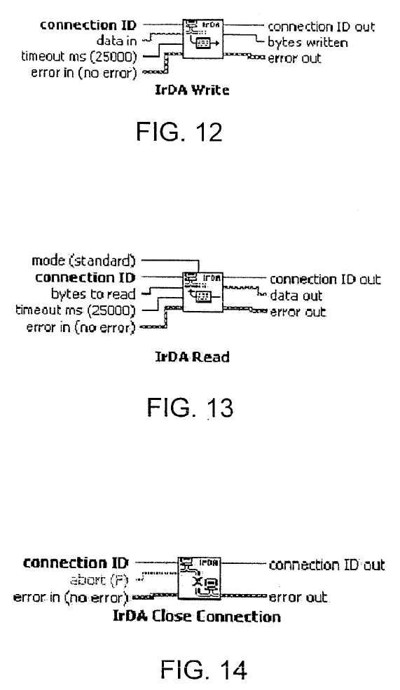

FIG. 12 illustrates an IrDA Write node. This node sends string data to the IrDA connection specified by connection ID. The following describes the inputs and outputs shown for this node:

“connection ID” is an IrDA connection refnum that uniquely identifies the IrDA connection.

“data in” is the data the function writes to an IrDA device. The data must be a string or a flattened string. The Flatten To String function can be used to convert any data that is not a string to the string format. The Unflatten From String function can be used to unflatten the string on the remote computer. Also, the Flatten To XML function can be used to convert data to the XML format.

“timeout ms” indicates how long the function should wait to send all bytes to an IrDA device on a wireless network before the function returns an error. The default value is 25,000 ms.

“error in” is similar as described above with reference to FIG. 8.

“connection ID out” is the IrDA connection refnum that uniquely identifies the IrDA connection. This value is used to refer to this connection in subsequent IrDA function calls. Always has the same value as connection ID.

“bytes written” indicates the number of bytes written to an IrDA connection on a wireless network.

“error out” is similar as described above with reference to FIG. 8.

FIG. 13 illustrates an IrDA Read node. This node reads the number of bytes specified in bytes to read from the IrDA connection specified in the connection ID. The remote computer sends the data as a string, even if the data is a different data type. The following describes the inputs and outputs shown for this node:

“mode” indicates the behavior of the read operation. A “mode” value of 0 (Standard-default) waits until all bytes requested have arrived or until the time specified in timeout ms runs out. Returns the number of bytes that have been received so far. If fewer bytes than the requested number arrive, returns the partial number of bytes and reports a timeout error. A “mode” value of 1 (Buffered) waits until all bytes requested have arrived or until the time runs out. If fewer bytes than the requested number of bytes arrive, returns no bytes and reports a timeout error. A “mode” value of 2 (CRLF) waits until receiving a CR (carriage return) followed by a LF (linefeed) within the number of bytes requested or until the time runs out. Returns the bytes received up to and including the CR and LF. If a CR and LF are not found, returns no bytes and reports a timeout error. A “mode” value of 3 (Immediate) waits until receiving any bytes. Waits the full timeout only if no bytes have been received. Returns the number of bytes received so far. Reports a timeout error if no bytes are received.

“connection ID” is an IrDA connection refnum that uniquely identifies the IrDA connection.

“bytes to read” indicates the requested number of bytes for the function to read from the IrDA device.

“timeout ms” indicates how long the function should wait for bytes from an IrDA device on a wireless network before the function returns an error. The default value is 25,000 ms.

“error in” is similar as described above with reference to FIG. 8.

“connection ID out” is the IrDA connection refnum that uniquely identifies the IrDA connection. This value is used to refer to this connection in subsequent IrDA function calls. Always has the same value as connection ID.

“data out” is the data the function reads from an IrDA device returned as a flattened string. The Unflatten From String function can be used to convert the data to the correct data type. Also, the Unflatten From XML function can be used to convert data from the XML format.

“error out” is similar as described above with reference to FIG. 8.

FIG. 14 illustrates an IrDA Close Connection node. This node closes the open infrared connection to the IrDA device specified by connection ID. The following describes the inputs and outputs shown for this node:

“connection ID” is an IrDA connection refnum that uniquely identifies the IrDA connection.

“abort” indicates how the connection closes. If “abort” is FALSE (default), the function closes the connection normally. If TRUE, the function aborts the connection.

“error in” is similar as described above with reference to FIG. 8.

“connection ID out” has the same value as connection ID. “connection ID out” should not be wired to other IrDA functions.

“error out” is similar as described above with reference to FIG. 8.

FIGS. 15 and 16 illustrate exemplary graphical programs utilizing the IrDA nodes shown in FIGS. 8-14. FIG. 15 illustrates a simple IrDA server application. This graphical program creates a service called temperatures, listens for a remote computer requesting this service, reads the temperature data the client collects, unflattens the string to an array of numbers, plots that data to a chart, and closes the connection.

FIG. 16 illustrates a simple IrDA client application. This graphical program discovers the device ID of the remote server, establishes a connection to the service called temperatures, flattens an array of numbers to a string, and writes temperature data to the server.

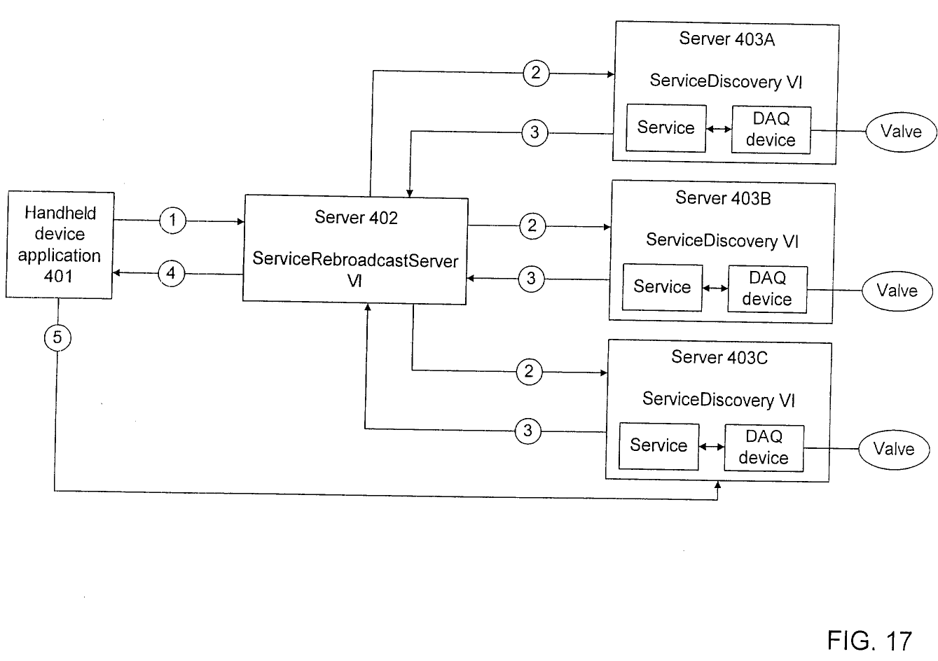

FIG. 17—Handheld Device Application

FIG. 17 illustrates one embodiment of a method for using wireless TCP/IP communication with a handheld computing device to access other devices and the services those devices offer. It is noted that the method of FIG. 17 is exemplary only. The following descriptions correspond to the numbered arrows:

1. The client on the handheld computing device connects to the server using TCP.

2. The server sends a UDP broadcast to the local sub-network that contains services the handheld computing device client wants to reference. The server requests services on behalf of the handheld computing device client because UDP broadcasts are not supported on some handheld computing device devices.

3. When a server receives the UDP broadcast, the VI running on the server checks its available services and replies if it has the services the handheld computing device client requested.

4. The server replies to the handheld computing device client via TCP which servers of the local sub-network replied as having the services the handheld computing device client requested.

5. The handheld computing device client connects to one of the servers to call a particular service.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for performing wireless communication in a graphical program, the method comprising:
storing the graphical program in a memory of a first computer system, wherein the first computer system includes first wireless communication hardware; and
executing the graphical program, wherein the graphical program executes to perform the wireless communication.

2. The method of claim 1,
wherein the graphical program comprises a graphical data flow program.

3. The method of claim 1,
wherein the graphical program comprises a plurality of interconnected nodes that visually indicate functionality of the graphical program.

4. The method of claim 3,
wherein the plurality of interconnected nodes visually indicate the wireless communication performed by the graphical program.

5. The method of claim 1,
wherein said graphical program executing to perform the wireless communication comprises the graphical program executing to cause the first wireless communication hardware to perform the wireless communication.

6. The method of claim 5,
wherein said graphical program executing to cause the first wireless communication hardware to perform the wireless communication comprises the graphical program executing to cause the first wireless communication hardware to send data to second wireless communication hardware.

7. The method of claim 5,
wherein said graphical program executing to cause the first wireless communication hardware to perform the wireless communication comprises the graphical program executing to cause the first wireless communication hardware to receive data from second wireless communication hardware.

8. The method of claim 1,
wherein the graphical program executes to communicate wirelessly with a program executing on a second computer system.

9. The method of claim 8,
wherein the program executing on the second computer system is a graphical program.

10. The method of claim 1, further comprising:
creating the graphical program, wherein said creating the graphical program comprises configuring the graphical program to perform the wireless communication.

11. The method of claim 10,
wherein said creating the graphical program comprises:
arranging a plurality of nodes on a display; and
interconnecting the plurality of nodes in response to user input.

12. The method of claim 10,
wherein said configuring the graphical program to perform the wireless communication comprises connecting a data source to a first node in the graphical program, wherein the first node is operable to wirelessly send data from the data source to a remote computer system.

13. The method of claim 10,
wherein said configuring the graphical program to perform the wireless communication comprises connecting a data sink to a first node in the graphical program, wherein the first node is operable to wirelessly receive data from a remote computer system and pass the data to the data sink.

14. The method of claim 10, further comprising:
displaying a graphical user interface for configuring the graphical program to perform the wireless communication;
receiving user input to the graphical user interface; and
configuring the graphical program to perform the wireless communication according to the user input received to the graphical user interface.

15. The method of claim 14,
wherein said receiving user input to the graphical user interface comprises receiving user input specifying a second computer system with which to perform the wireless communication;
wherein said configuring the graphical program to perform the wireless communication according to the user input received to the graphical user interface comprises configuring the graphical program to perform the wireless communication with the second computer system.

16. The method of claim 14,
wherein said receiving user input to the graphical user interface comprises receiving user input specifying one or more communication properties;
wherein said configuring the graphical program to perform the wireless communication according to the user input received to the graphical user interface comprises configuring the graphical program to perform the wireless communication according to the one or more specified communication properties.

17. The method of claim 1, wherein said performing the wireless communication comprises performing one or more of the following types of communication:
infrared communication;
802.11 communication;
Bluetooth communication;
HomeRF communication;
TCP/IP communication.

18. The method of claim 1,
wherein the graphical program comprises a block diagram portion and a user interface portion.

19. The method of claim 1,
wherein the graphical program executes to cause the first wireless communication hardware to perform the wireless communication to perform one or more of:
an industrial automation function;
a process control function;
a test and measurement function.

20. A method for performing wireless communication in a graphical program, the method comprising:
creating the graphical program, wherein said creating the graphical program comprises configuring the graphical program to perform the wireless communication;
storing the graphical program in a memory; and
executing the graphical program, wherein said executing the graphical program comprises performing the wireless communication.

21. A method for performing wireless communication in a graphical program, the method comprising:
creating the graphical program, wherein said creating the graphical program comprises configuring the graphical program to communicate wirelessly with a first computer system;
storing the graphical program in a memory of a second computer system; and
executing the graphical program, wherein said executing the graphical program comprises performing wireless communication to communicate with the first computer system.

22. A method for creating a graphical program that performs wireless communication, wherein the method operates in a computer including a display screen and a user input device, the method comprising:
displaying on the screen a first node in the graphical program in response to user input; and
configuring the first node to perform the wireless communication;
wherein, during execution of the graphical program, the first node is operable to perform the wireless communication.

23. The method of claim 22,
wherein the graphical program comprises a graphical data flow program.

24. The method of claim 22,
wherein the graphical program comprises a plurality of interconnected nodes that visually indicate functionality of the graphical program.

25. The method of claim 22,
wherein said configuring the first node to perform the wireless communication comprises one or more of:
configuring the first node to send data to a first wireless address; and/or
configuring the first node to receive data from the first wireless address.

26. The method of claim 22, further comprising:
displaying on the screen a second node in the graphical program in response to user input;
wherein said configuring the first node to perform the wireless communication comprises connecting a wire from the second node to the first node, wherein the wire visually indicates that data is propagated from the second node to the first node;
wherein the first node is operable to wirelessly send the data propagated from the second node to the first node.

27. The method of claim 22, further comprising:
displaying on the screen a second node in the graphical program in response to user input;
connecting a wire from the first node to the second node, wherein the wire visually indicates that data is propagated from the first node to the second node;
wherein the first node is operable to wirelessly receive data and propagate the received data to the second node.

28. The method of claim 22,
wherein said configuring the first node to perform the wireless communication comprises configuring the first node with information specifying a wireless address with which to communicate.

29. The method of claim 22, further comprising:
executing the graphical program;
wherein said executing the graphical program includes executing the first node;
wherein the first node executes to perform the wireless communication.

30. The method of claim 22, wherein the first node is operable to perform one or more of the following types of communication:
infrared communication;
802.11 communication;
Bluetooth communication;
HomeRF communication;
TCP/IP communication.

31. A system for enabling a first graphical program to communicate with a second graphical program, the system comprising:
a first computer system including:
a first processor;
a first memory coupled to the first processor, wherein the first memory stores the first graphical program; and
a second computer system including:
a second processor;
a second memory coupled to the second processor, wherein the second memory stores the second graphical program;
wherein the first processor is operable to execute the first graphical program, wherein the first graphical program is configured to wirelessly send first data to the second graphical program;
wherein the second processor is operable to execute the second graphical program, wherein the second graphical program is configured to receive the first data sent by the first graphical program.

32. The system of claim 31,
wherein the second graphical program is configured to wirelessly send second data to the first graphical program;
wherein the first graphical program is configured to receive the second data sent by the second graphical program.

33. A system for performing wireless communication, the system comprising:
a first computer system; and
a handheld computing device including a processor and a memory that stores a graphical program;
wherein the graphical program stored in the memory of the handheld computing device is configured to perform wireless communication;
wherein the processor of the handheld computing device is operable to execute the graphical program to communicate wirelessly with the first computer system.

34. The system of claim 33,
wherein the handheld computing device includes first wireless communication hardware;
wherein the first computer system includes second wireless communication hardware;
wherein said executing the graphical program to communicate wirelessly with the first computer system comprises one or more of:
executing the graphical program to cause the first wireless communication hardware to send data to the second wireless communication hardware; and/or
executing the graphical program to cause the first wireless communication hardware to receive data from the second wireless communication hardware.

35. The system of claim 33,
wherein said executing the graphical program to communicate wirelessly with the first computer system comprises executing the graphical program to communicate with a graphical program executing on the first computer system.

36. The system of claim 33, wherein the handheld computing device comprises one or more of:
a personal digital assistant (PDA);
a cellular telephone;
a wearable computing device.

37. The system of claim 33,
wherein the processor of the handheld computing device is operable to execute the graphical program to communicate wirelessly with the first computer system using one or more of the following types of communication:
infrared communication;
802.11 communication;
Bluetooth communication;
HomeRF communication;
TCP/IP communication.
